(19) United States
(12) Patent Application Publication
(10) Pub. No.: US 2026/0248250 A1
(43) Pub. Date: Aug. 27, 2026

(54) MOBILE DEVICE CASE

(71) Applicants: Joseph Grazi, Oakhurst, NJ (US); Joy Grazi, Oakhurst, NJ (US)

(72) Inventors: Joseph Grazi, Oakhurst, NJ (US); Joy Grazi, Oakhurst, NJ (US)

(21) Appl. No.: 19/061,701

(22) Filed: Feb. 24, 2025

(51) Int. Cl. A45C 11/00; A45C 13/02; H04B 1/3888

(52) U.S. Cl. CPC A45C 11/002; A45C 13/02; H04B 1/3888

(57) ABSTRACT

A mobile device case having a protective shell and at least one raised section positioned on the protective shell. The protective shell includes a back wall and a skirt formed as a unitary element with the back wall. The back wall and the skirt are sized and configured to receive and retain a mobile device within the protective shell. The raised section is located on the back wall of the protective shell, and includes a base portion and a table top portion. A surface area and a perimeter of the table top portion is greater than a surface area and a perimeter of the base portion so as to form a groove under the table top portion and adjacent to the base portion, this groove being configured to receive and retain a hair tie therein.

### RELATED APPLICATIONS

None.

### BACKGROUND

The invention generally relates to the field of mobile device cases and, more specifically, relates to a protective mobile device case with auxiliary functions.

A mobile device is a small, lightweight computing device, typically small enough to be handheld, having a display screen with a touch-screen input or a miniature keyboard. A handheld computing device has an operating system (OS), and can run various types of application software, known as apps. Most handheld devices can also be equipped with Wi-Fi, Bluetooth, NFC, and GPS capabilities that can allow connections to the Internet and other devices, such as an automobile or a microphone headset, or can be used to provide location-based services. A camera is often also incorporated into the mobile device. Such camera may include multiple lenses positioned on the reverse side of the device from the screen. Mobile devices may provide biometric user authentication using a built-in camera for face recognition or using a fingerprint sensor for fingerprint recognition.

Because modern mobile devices contain expensive hardware that provides a wide variety of functions, it has become increasingly popular to equip them with protective cases. Mobile device cases may help make a device more resistant to potential damage encountered in everyday use. Cases may also add an aspect of fashion or individuality to a user's device.

A hair tie (also known as a ponytail holder, hair-keeper, hair band, hair elastic, or wrap around) is a styling aid used to fasten hair, particularly long hair, away from areas such as the face. To avoid losing hair ties users often wrap them around their wrists, place them in their pockets or wrap these hair ties around their phones. Unfortunately, hair ties wrapped around the phones interfere with the operation of the touch-screen and may slide over the camera lenses and interfere with the operation of the phone camera. Therefore, there is a need in the art for a mobile device case which would include an accessory accommodating at least one hair tie without interfering with any function of the mobile device.

### SUMMARY

In its general aspect, the invention is a mobile device case having a protective shell and at least one raised section positioned on the protective shell. The protective shell includes a back wall and a skirt formed as a unitary element with the back wall. The back wall and the skirt are sized and configured to receive and retain a mobile device within the protective shell. The raised section is located on the back wall of the protective shell, and includes a base portion and a table top portion. A surface area and a perimeter of the table top portion is greater than a surface area and a perimeter of the base portion so as to form a groove under the table top portion and adjacent to the base portion, this groove being configured to receive and retain a hair tie therein.

One of the key features of the invention is that when the hair tie is positioned and retained within the groove of the raised section, the hair tie does not interfere with any operations of the mobile device positioned within the case.

### BRIEF DESCRIPTION OF THE DRAWINGS

The invention is illustrated by way of examples which are not a limitation, and the figures of the accompanying drawings in which references denote corresponding parts, and in which:

FIG. 1 shows a side perspective view of the mobile device casing in accordance with the preferred embodiment of the present invention;

FIG. 2 shows a rear view of the mobile device casing in accordance with the preferred embodiment of the present invention;

FIG. 3 shows a rear view of the mobile device casing with the mobile device being inserted into the casing;

FIG. 4 shows a side view of the mobile device casing in accordance with the preferred embodiment of the present invention; and

FIG. 5 shows a side perspective view of the mobile device casing with the mobile device being inserted into the casing.

### DESCRIPTION

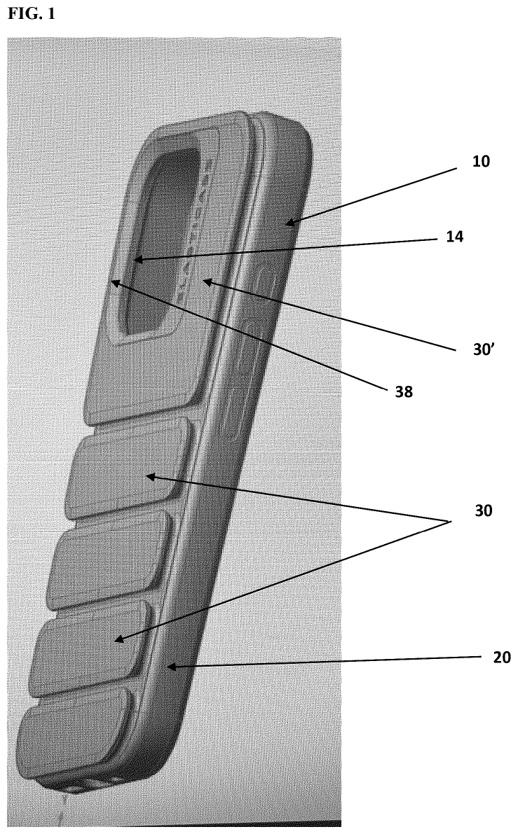

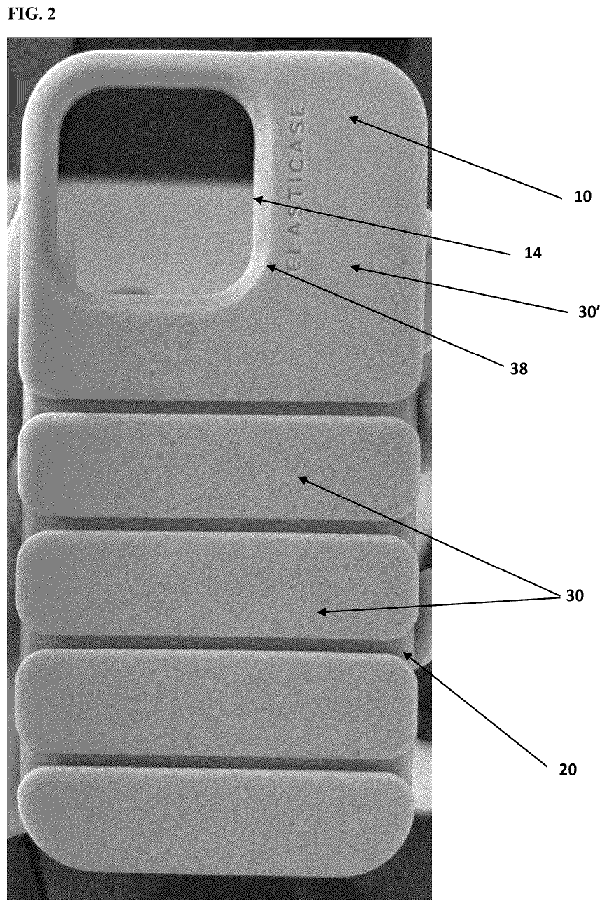

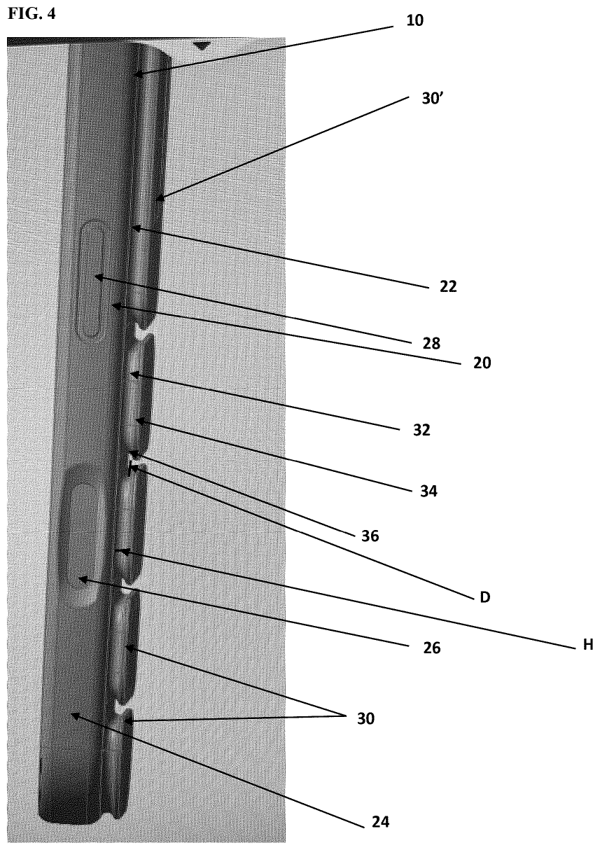

As shown in FIGS. 1-5, in its preferred embodiment, the mobile device case 10 includes a protective shell 20 and a plurality of raised sections 30 located on the protective shell 20.

As shown in FIGS. 1 and 4-5 , protective shell 20 includes a back wall 22 and a skirt 24, which is preferably formed as a unitary element with the back wall 22. The back wall and the skirt of the protective shell are preferably sized to accommodate a mobile device 12 within the protective shell. In use, the mobile device 12 is positioned inside the protective shell 20 such that the device's backside is located adjacent to an inner side of the back wall 22, and the skirt 24 securely protects the edges of the mobile device. The skirt and the back wall of the protective shell preferably include a plurality of apertures 26 and flexible button covers 28. Apertures 26 and flexible button covers 28 are structured and arranged to accommodate and to allow protective access to various controls, ports and buttons of the mobile device 12. The back wall 22 may also include a camera aperture 14, which is sized to accommodate camera lenses 16 of the mobile device 12 without interfering with camera operations. Protective shell 20 is preferably made of a durable material selected to protect the mobile device 12 in case of an impact. In the preferred embodiment, protective shell 20 is constructed of plastic and/or rubber, and is structured to allow normal signal transmission of said mobile device. In addition to plastic and rubber, any other suitable material, for example, leather, silicon, polycarbonate, thermoplastic polyurethane, acrylic, wood, aluminum or a hybrid material of any of the above, may be utilized to construct the protective shell 20.

As further shown in FIGS. 1-5, multiple raised sections 30 are located on the back wall 22 of the protective shell 20. In the preferred embodiment, raised sections 30 are formed unitarily with the protective shell 20, for example, by an injection molding process. However, each individual raised section 30 can be formed separately and then fixedly attached to the back wall 22, for example, by an adhesive. If formed separately, raised sections 30 may be made of a material different from the material of the protective shell 20.

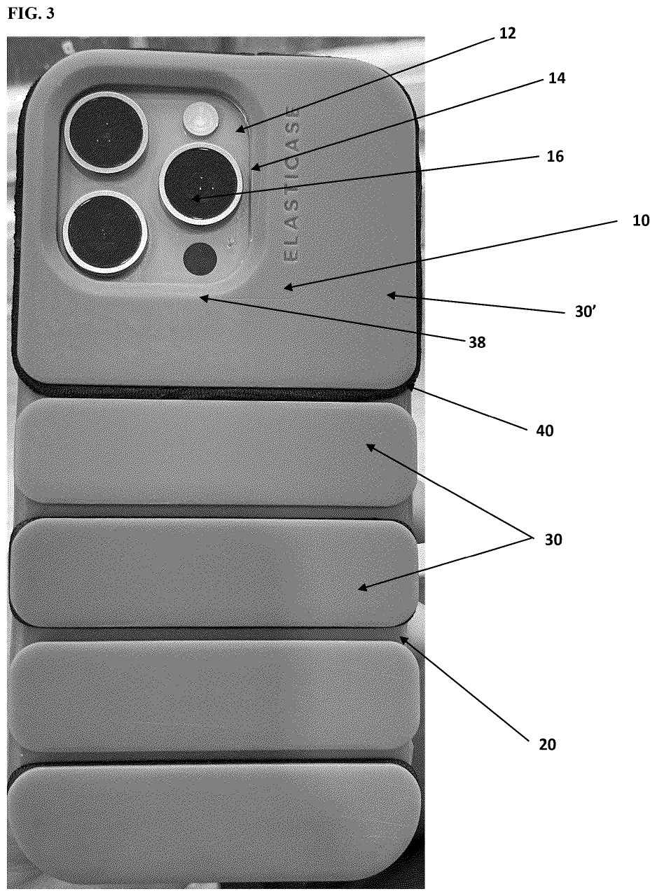

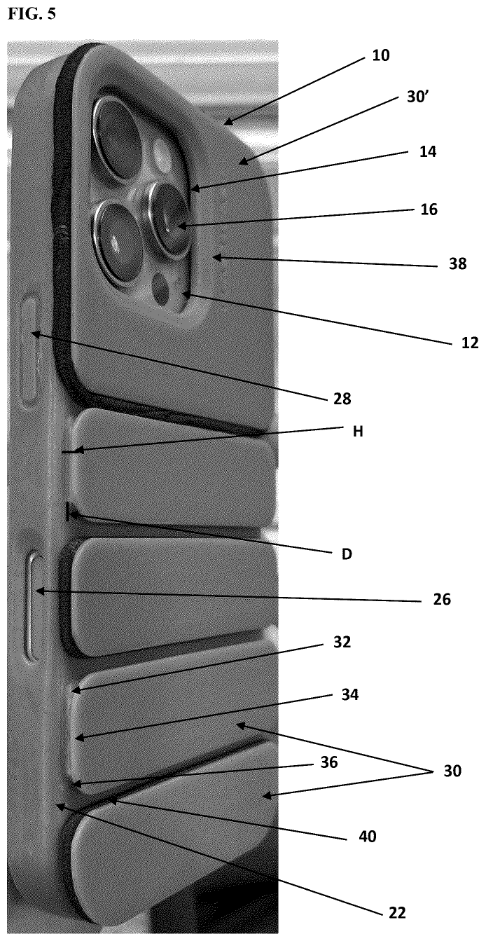

As shown in FIGS. 1 and 4-5, each raised section 30 preferably includes a base portion 32 and a table top portion 34. The perimeter and the surface area of the table top portion 34 of each raised section 30 is larger than the perimeter and the surface area of its corresponding base portion such that a groove 36 is formed around each base portion of each raised section 30 under its table top portion. Each groove 36 is sized to accommodate and retain therein a hair tie 40, as shown in FIGS. 3 and 5. Specifically, each groove preferably has a height H, defined as the distance from the back wall 22 to the table top portion 34, ranging from 1 mm to 10 mm, and a depth D, defined as the distance from the surface of the base portion 32 to an imaginary surface drawn perpendicularly to the back wall 22 at the edge of the table top portion 34, ranging from 1 mm to 10 mm. When hair ties 40 are positioned within grooves 36 of the raised sections 30, each hair tie is securely wrapped around the base portion of one of the raised sections and, thus, does not obstruct access to apertures 26, or interfere with operations of flexible button covers 28.

As shown in the drawings, raised sections 30 are substantially quadrilateral in shape and can vary in sizes to accommodate various sizes of hair ties, as well as, various components of the mobile device 12. For example, the top raised section 30′ may be made larger than the rest of the raised sections 30 and may include an aperture 38, substantially corresponding in size to the camera aperture 14, to accommodate camera lenses 16 of the mobile device 12 without interfering with camera operation. For ease of formation and/or operation, aperture 38 may also be formed slightly larger than the aperture 14. Because of its larger size, raised section 30′ can also accommodate longer hair ties.

While the drawings show the mobile device case 10 as being provided with multiple raised sections 30, it should be understood by a person skilled in the art that the mobile device case 10 may be formed with a single raised section 30 to accommodate a single hair tie. Where multiple raised sections 30 are formed on the back wall 22, the raised sections are spaced apart from each other by at least 1 mm, and preferably by 2 mm, as measured at their table top portions, to make sure that hair ties can be securely inserted into the grooves of the adjacent raised sections 30.

In use, the user will extend the hair tie, wrap it around a selected raised section 30, position the hair tie into the groove 36 of the selected raised section 30, and release the tension of the hair tie to snugly and securely accommodate the hair tie within the groove. To remove the hair tie from the mobile device case 10, the user will extend a portion of the hair tie and pull the hair tie from the groove, thus separating the hair tie from the selected raised section 30. The user can choose to wrap his/her hair ties around one or multiple raised sections 30. Additionally, depending on the diameter of the hair tie and the dimensions of the groove 36, multiple hair ties can be wrapped around the same raised section 30. Thus, the structure of the inventive mobile device case allows its user to secure hair ties on the mobile device case without interfering with any functions of the mobile device.

The mobile device case 10 may be offered in various configurations to accommodate the differing commercial phones and devices on the market. The case may also be sold in a variety of colors and aesthetic designs. In some embodiments, the case may also include adapters for charging accessories.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

We claim as follows:

1. A mobile device case comprising:
a protective shell having a back wall and a skirt formed as a unitary element with said back wall, said back wall and said skirt of said protective shell being sized and configured to receive and retain a mobile device within said protective shell; and
at least one raised section located on said back wall of said protective shell, said raised section having a base portion and a table top portion, a surface area and a perimeter of said table top portion being greater than a surface area and a perimeter of said base portion so as to form a groove under said table top portion and adjacent to said base portion, said groove being configured to receive and retain a hair tie therein.

2. The mobile device case according to claim 1, further comprising a plurality of said raised sections, said raised sections being positioned adjacent to each other and being spaced apart from each other by at least 1 mm.

3. The mobile device case according to claim 2, wherein each of said raised section is substantially quadrilateral in shape.

4. The mobile device case according to claim 2, wherein said back wall of said protective shell further comprises a first aperture sized to accommodate camera lens of said mobile device without interfering with operations of said camera, wherein at least one of said raised sections is positioned over an area of said back wall where said first aperture is located, wherein said at least one of said raised sections includes a second aperture corresponding in size and shape to said first aperture so as to also accommodate said camera lens of said mobile device without interfering with operations of said camera, and wherein when said hair tie is positioned within the groove of said at least one of said raised sections positioned over the area of said back wall where said first aperture is located, said hair tie does not interfere with operations of said camera.

5. The mobile device case according to claim 2, wherein said groove of each of said raised sections has a height ranging from 1 mm to 10 mm and a depth ranging from 1 mm to 10 mm.

6. The mobile device case according to claim 2, wherein said raised sections are spaced apart from each other by at least 2 mm.

7. The mobile device case according to claim 2, wherein said protective shell further comprises a plurality of apertures and flexible button covers, and wherein when said hair ties are positioned within said grooves of said raised sections said hair ties do not obstruct access to said apertures or interfere with operations of said flexible button covers.
